(19) United States
(12) Patent Application Publication
(10) Pub. No.: US 2008/0026729 A1
(43) Pub. Date: Jan. 31, 2008

(54) Method and apparatus for configuring unique profile settings for multiple services

(75) Inventors: Darrell R. May, Waterloo (CA); Andrew Bocking, Waterloo (CA)

Correspondence Address: PERRY + CURRIER (FOR RIM), 1300 YONGE STREET, SUITE 500, TORONTO, ON, M4T-1X3, US

(73) Assignee: RESEARCH IN MOTION LIMITED

(21) Appl. No.: 11/495,779

(22) Filed: Jul. 31, 2006

(51) Int. Cl. H04Q 7/38

(52) U.S. Cl. 455/414.1

(57) ABSTRACT

An apparatus and method are provided for configuring unique profile settings for multiple services associated with an application in an electronic device. A profile system is provided having multiple programmable profile settings and a default profile setting for the application. Service records are received at the electronic device for each of the multiple services. The multiple services register with the profile system using a unique ID for each of the service records and include data for identifying the default profile setting for the application. Initially, the default profile setting is assigned to each of the multiple services. Subsequently, the multiple programmable profile settings are assigned to respective ones of the multiple services.

### FIELD

The present application relates generally to electronic devices and more particularly to a method and apparatus for configuring unique profile settings for multiple services in connection with which an electronic device is provisioned.

### BACKGROUND

Electronic devices such as wireless personal digital assistants (PDAs), smart telephones and laptop computers with wireless capabilities are well known for providing users with services such as e-mail, Web browsing, text messaging, etc. Such devices communicate over a wide variety of networks including data-only networks such as Mobitex and DataTAC as well as complex voice and data networks such as GSM/GPRS, CDMA, EDGE, UMTS and CDMA2000 networks.

It is known to provide multiple user-selectable profiles (e.g. loud, discreet, quiet, etc.) for notifying or alerting the user to service activity (e.g. incoming call or e-mail message, calendar event, daily alarm, etc.). On device start-up, each application (e.g. calendar, e-mail, phone, etc.) registers with a profile system using a unique ID, to facilitate programming of an individual profile setting for each application.

Some users may have multiple services that they wish to access through the device. For example, some users may wish to access multiple e-mail accounts, and other types of data services, all or some of which may be provided by different service providers.

Although it is known to select a profile for application to a particular service, it would be desirable to apply a unique profile setting to each of multiple services (e.g. a unique profile setting for each of a user's multiple e-mail accounts).

### BRIEF DESCRIPTION OF THE DRAWINGS

FIG. 1 is a schematic representation of a electronic device with a graphical user interface for programming profile settings for different applications;

FIG. 2 is a block diagram of certain internal components within the electronic device of FIG. 1;

FIG. 3 is a block diagram of a communication system with which the electronic device of FIGS. 1 and 2 communicates;

FIG. 4 is a block diagram of a profile system forming part of the electronic device of FIGS. 1 and 2, according to an exemplary embodiment;

FIG. 5 is a schematic representation of the electronic device with a graphical user interface for programming profile settings for different services, according to an exemplary embodiment;

FIG. 6 is a flowchart showing a method for configuring unique profile settings for multiple services according to an exemplary embodiment; and

FIG. 7 is a flowchart showing a method for configuring unique profile settings for multiple services according to a further embodiment.

### DETAILED DESCRIPTION OF THE EMBODIMENT

According to one aspect there is provided a method for configuring unique profile settings for multiple services associated with an application in an electronic device, including: providing a profile system having multiple programmable profile settings and a default profile setting for the application; receiving service records for the multiple services; registering the multiple services with the profile system using, a unique ID for each of the service records and data for identifying the default profile setting for the application; initially assigning the default profile setting to each of the multiple services; and subsequently assigning the multiple programmable profile settings to respective ones of the multiple services.

By providing multiple unique profile settings for different services, the user may set a different ring tone, volume, etc., for each service (e.g. separate e-mail accounts) to which the user has subscribed.

According to an additional aspect, the ID associated with each service for registration with the profile system also identifies a default root profile setting that permits later registration with the profile system in circumstances where no service record for the service has yet been downloaded to the device. This facilitates migration of profile settings that have been programmed before Over-the-Air (OTA) device synchronization following a software upgrade, or after a system restore operation.

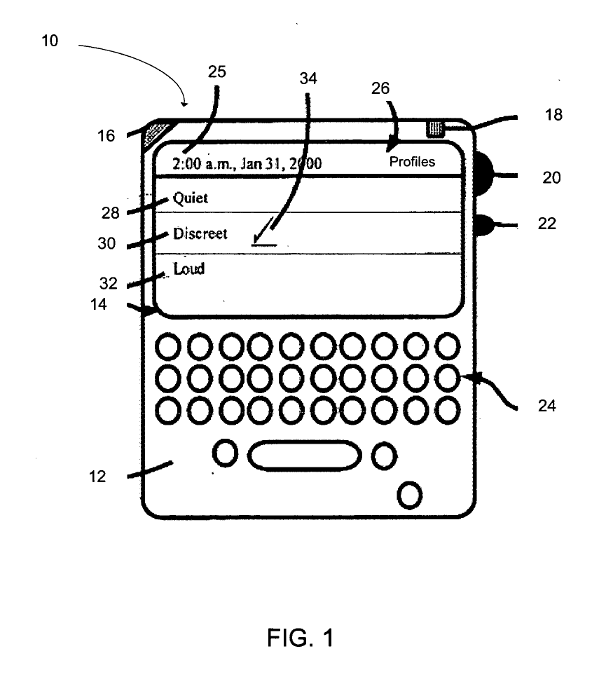

Reference is first made to FIG. 1, showing an electronic device 100 based on the computing environment and functionality of a wireless personal digital assistant. It is, however, to be understood that electronic device 10 can include the construction and functionality of other electronic devices, such as desktop computers, cell phones, smart telephones, and laptops with wireless 802.11 or bluebook chip sets and the like. In one embodiment, electronic device 10 includes a housing 12, which frames an LCD display 14, as well as a speaker 16, an LED indicator 18, a trackwheel 20, an exit key 22 and a key pad 24. Trackwheel 20 and exit key 22 can be inwardly depressed to provide additional user-input. In the illustrated embodiment, LCD display 14 depicts a system clock 25 and additional information, such as generated by a “Profiles” application 26, as discussed in greater detail below

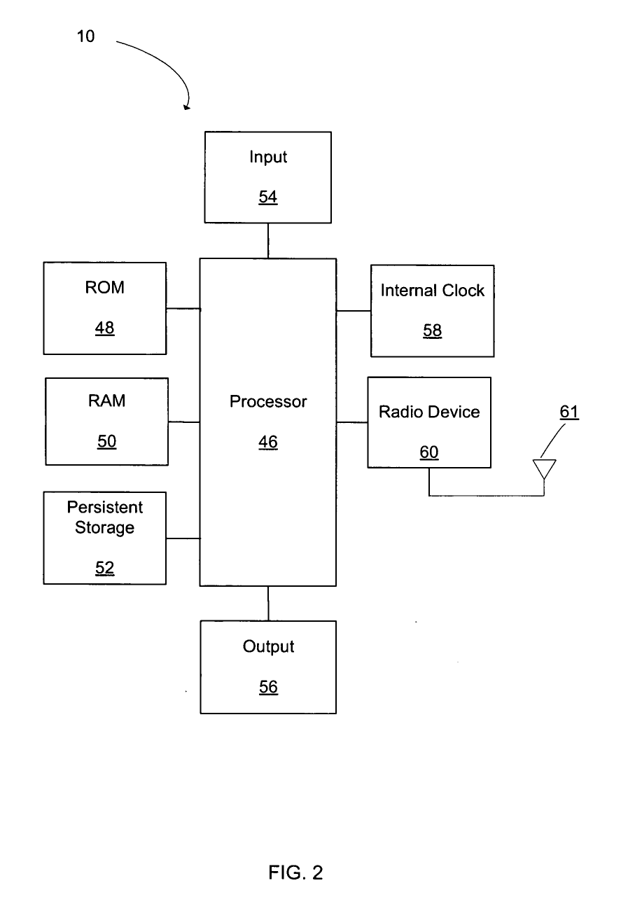

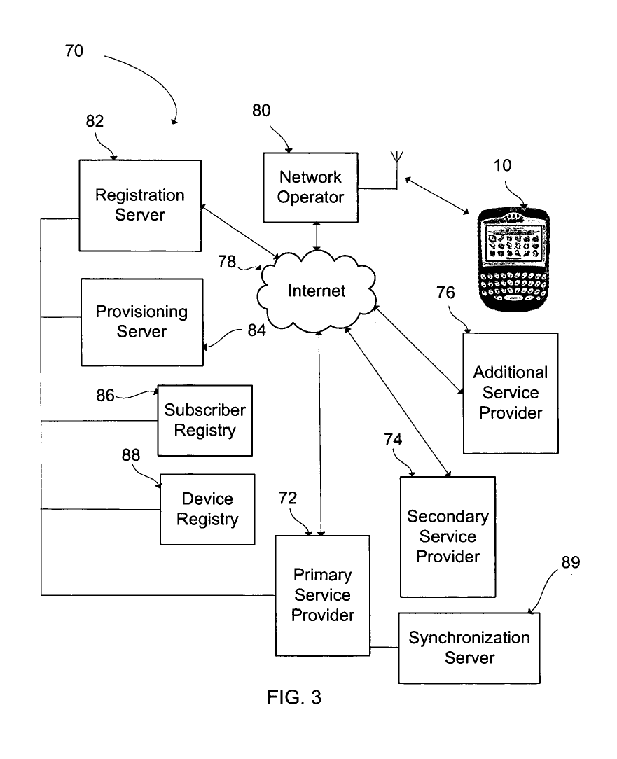

Turning briefly to FIG. 2, certain internal components within the electronic device 10 are illustrated by way of a block diagram. The electronic device 10 is based on a microcomputer that includes a processor 46 connected to a read-only-memory (ROM) 48 that contains a plurality of applications executable by the processor 46 to enable the electronic device 10 to provide certain services (e.g. calendar, e-mail, phone, etc.). The processor 46 is also connected to a random access memory (RAM) 50 and a persistent storage device 52, which is responsible for various non-volatile storage functions of the electronic device 10. The processor 46 receives input from input devices 54 such as key pad 24, trackwheel 20 and exit key 22 (FIG. 1). The processor 46 outputs to output devices 56 such as LCD display 14, LED indicator 18 and speaker 16 (FIG. 1). The processor 46 is also connected to an internal clock 58 and a radio device 60 which, in turn, is connected to an antenna 61. Together, the radio device 60 and the antenna 61 are used to communicate over a wireless network. As discussed in greater detail below with reference to FIG. 3, the electronic device 10 is operable to receive and transmit communication signals containing data that is communicated to and from a communication system via the radio device 60 and the antenna 61.

Returning to FIG. 1, LCD display 14 of electronic device 10 may be used to display different notification profiles using “Profiles” application 26. This allows the user to program customized notification or alerting profiles. A plurality of notification profiles is shown: Quiet 28, Discreet 30, and Loud 32. Each of these profiles can be customized by the manufacturer or by the user according to user preference, and can also be deleted or supplemented with additional profiles as desired. The following Table shows how each profile can be customized:

An Example of Customizing Methods of Notification

| Mode of | | |
|---|---|---|
| Notification | Application | Notification Behaviour |
| Quiet | Message Reader | Type: Inaudible |
| | | Tune: None |
| | | Volume: Mute |
| | Daily Alarm | Type: Audible |
| | | Tune: Ring 2 |
| | | Volume: Low |
| Discreet | Message Reader | Type: Audible & Inaudible |
| | | Tune: Ring 3 |
| | | Volume: Medium |
| | Daily Alarm | Type: Audible |
| | | Tune: Ring 1 |
| | | Volume: Low |
| Loud | Message Reader | Type: Audible |
| | | Tune: Ring 5 |
| | | Volume: High |
| | Daily Alarm | Type: Audible |
| | | Tune: Ring 6 |
| | | Volume: High |

Checkmark 34, located beside the profile “Discreet”, in FIG. 1, indicates that the default mode of notification for the present example is Discreet 30. Trackwheel 20 can be used to scroll through the different profiles and to select a particular profile for each application (e.g. message reader (email), daily alarm, calendar, etc.).

As illustrated in the foregoing Table, each profile can give rise to a different notification output for various applications on device 10, and notification behavior can be customized according to a variety of criteria, such as “type”, “tune” and “volume”. “Type” can be either audible or inaudible. Audible means a sound emanating from speaker 16 and inaudible means a light flashing from LED indicator 18. “Tune” can be any tune chosen by the manufacturer or the user and programmed into device 10. This is the tune that would be played by speaker 16 when “type” is set to audible. “Volume” determines the volume of the tune and in the present embodiment can be low, medium or high.

It will be apparent to those skilled in the art that the foregoing Table is just one example of the way in which notifications can be customized. Furthermore, the specific types, tunes and volumes outlined in this Table are not particularly limited. Also the list of specific applications associated with each mode is not particularly limited and can match the complete set of applications on device 10.

Turning now to FIG. 3, a communication system is shown over which the electronic device 10 communicates. More particularly, a system 70 is shown for provisioning a plurality of services to the electronic device 10. Thus, for example, a first e-mail account (e.g. Rogers™ e-mail) may be provided by a primary service provider 72, and a second e-mail account (e.g. Yahoo!™ email account) may be provided by a secondary service provider 74. Additional service providers, such as service provider 76, may provide further services. System 70 and service providers 72, 74, 76, etc., communicate over Internet 78, in a well-known manner. Electronic device 10 also communicates over Internet 78 via wireless services provided by a network operator 80.

The system 70 includes a registration server 82, a provisioning server 84, a subscriber registry 86 and a device registry 88. The system 70 is shown operating under control of the primary service provider 72, although the system 70 may operate under control of the secondary service provider 74, the additional service provider 76, or independently of any service provider.

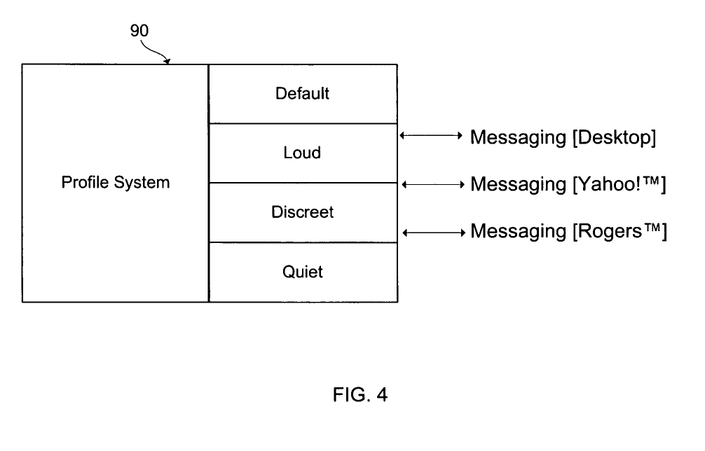

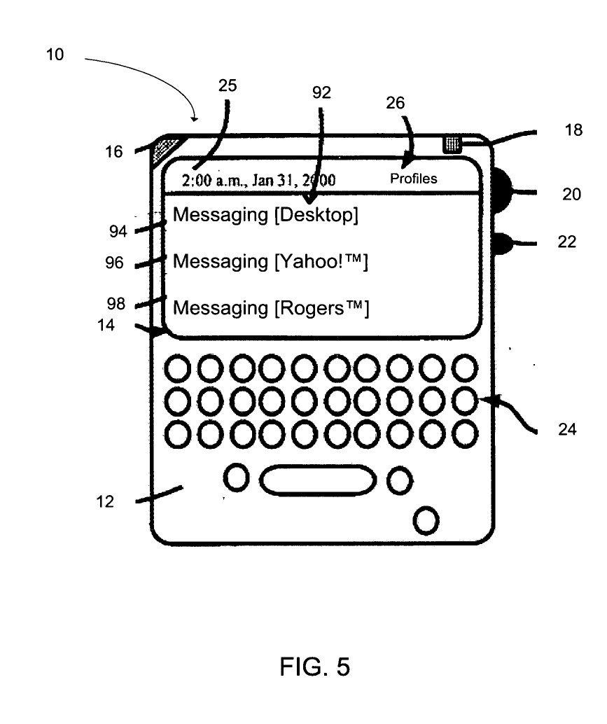

The system 70 may also include a synchronization server 89 for performing data synchronization with the electronic device, as discussed in greater detail below with reference to FIGS. 4 and 5.

It is conventional for the primary service provider 72 to store an IP address of the registration server 82 within electronic device 10, at the time the device is delivered to the user. Upon initially activating the electronic device 10, the device detects the presence of the wireless network controlled by network operator 80 and uses the stored address of the registration server 82 to send a registration request to the registration server. The registration request includes an identification code for the device 10, the identity of the user, and the identity of the network operator 80.

Upon receipt of the registration request, server 82 attempts to authenticate the request and, if successful, extracts the information in the request message and transmits it to the provisioning server 84. Provisioning server 84 determines whether the user is permitted to provision the associated service by checking the status of the user in subscriber registry 86. Similarly, provisioning server 84 checks the status of the device in device registry 88. If provisioning server 84 is unable to approve the registration request based on the status of the user or the device as maintained in the subscriber registry 86 and/or the device registry 88 then provisioning server 84 typically either disallows or delays the registration request while the subscriber's status is checked in real-time with the network operator 80.

If the provisioning server 84 is able to approve the registration request then, the provisioning server 84 transmits (or “pushes”) a service book (or multiple service books) to the device 10 that contains data and instructions to enable the device 10 to provision the associated service provided by service provider 72. The service book is configured to become active upon receipt at the device 10 to permit the user to enter a desired user ID and a desired password for the associated service.

The device 10 then transmits the user ID and password specified by the user for the associated service to provisioning server 84. Communication between the electronic device and the provisioning server 84 may be protected using encryption or other techniques, such as transport layer security (TLS). The provisioning server 84 determines if an account for the associated service may be created using the user ID and password specified by the user. If the account may be created, then provisioning server 84 creates the associated service account for device 10 in the associated server provider system 72 and downloads a corresponding service book to the electronic device 10. The corresponding service book contains service records such as a Compressed Multipurpose Internet Mail Extensions (CMIME) service record, for example.

If the user wishes to associate additional services, provisioning server 84 permits the user to specify details relating to each additional service. For example, the user may enter the e-mail address, username and password for the additional service (which may be provided by secondary service provider 74 or additional service provider 76). This information is transmitted to the provisioning server 84 which then attempts to contact the additional service provider system (e.g. secondary service provider 74 or additional service provider 76) to associate the additional service with the primary service provided by the primary service provider 72.

If the provisioning server 84 is able to configure the additional service to operate with the primary service, it pushes a new service book to the electronic device 10 that is similar to the initial service book, except that it is preferably not configured to become active automatically when received at the device 10. The new service book may be executed on electronic device 10 at the request of the user and may be used to associate additional services with the primary service. As indicated above, upon creation of the additional service account for device 10 in the associated server provider system 72, the provisioning server 84 downloads a further service book to the electronic device 10.

According to an exemplary embodiment, as shown in FIG. 4, a profile system 90 is provided having multiple programmable profile settings (e.g. Loud, Discreet, Quiet, and, although not shown, optionally also vibrate, LED flash, etc.), and a default profile setting that is initially assigned to each application (e.g. calendar, messaging, tasks, alarm, etc.). In response to receipt of service records for multiple services associated with an application (e.g. multiple e-mail accounts associated with the messaging application), the multiple services register with the profile system using a unique ID for each service record. Thus, for the exemplary embodiment of FIG. 4, each of the multiple messaging services (i.e. Messaging [Desktop], Messaging [Yahoo!™], Messaging [Rogers™], etc.) registers with the profile system 90. As part of the registration process, each of the multiple services transmits data to the profile system 90 for identifying the default profile setting for the associated application (i.e. Messaging).

In response, profile system 90 initially assigns the default profile setting to each of the multiple services pending receipt of profile setting data whereupon individual programmable profile settings are assigned to respective ones of the multiple services.

As shown in FIG. 5, a user interface 92 is provided for entering profile setting data. By highlighting and then clicking any of the services (Messaging [Desktop] 94, Messaging [Yahoo!™] 96, Messaging [Rogers™] 98, etc.) using trackwheel 20, the list of notification profiles Quiet 28, Discreet 30, and Loud 32 are displayed, as shown in FIG. 1. The user may then enter profile setting data by selecting one of the profiles (e.g. “Discreet) using the trackwheel 20.

In some cases, such as during a system restore or after a software version upgrade, the user's programmed profiles will be reset. However, the profile setting data for the programmed profiles will have been stored on synchronization server 89 as a result of a previous routine data synchronization between the electronic device 10 and the synchronization server 89. Hence, when the device 10 and server 89 perform the next data synchronization the profile setting data may be downloaded to the electronic device 10 before the user's multiple services (e.g. e-mail accounts) have been provisioned. Consequently, the profile system 90 has no services against which to apply the profile setting data.

In this case, the profile setting data is stored in the profile system 90 but marked as hidden files. If no service records for the services in connection with which hidden profile settings have been stored are received by the device 10 within a predetermined period of time (e.g. 7 days), the hidden files are discarded during a subsequent synchronization process.

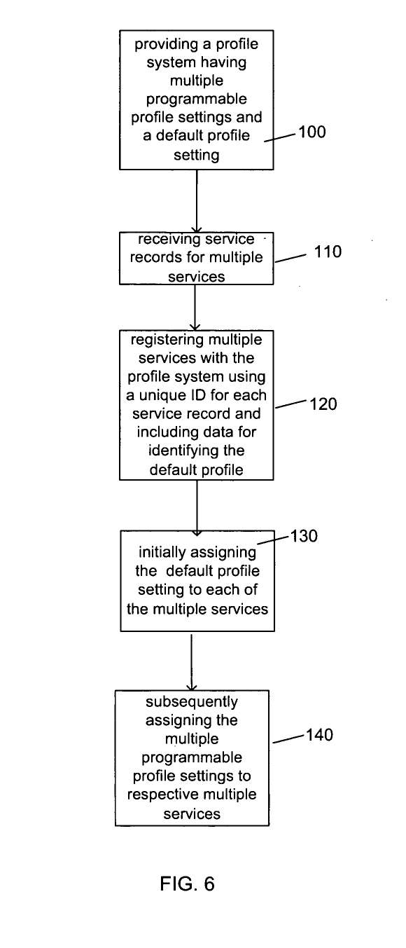

Turning to FIG. 6, a flowchart is provided showing a method for configuring unique profile settings for multiple services according to an exemplary embodiment. In step 100, profile system 90 is provided having multiple programmable profile settings and a default profile setting for the application (e.g. messaging). In step 110, service records are received for the multiple services from provisioning server 84. In step 120, the multiple services register with the profile system 90 using a unique ID for each service record and including data for identifying the default profile setting for the application. In step 130, the default profile setting is initially assigned to each of the multiple services. Then, at step 140, the multiple programmable profile settings are subsequently assigned to respective ones of the multiple services.

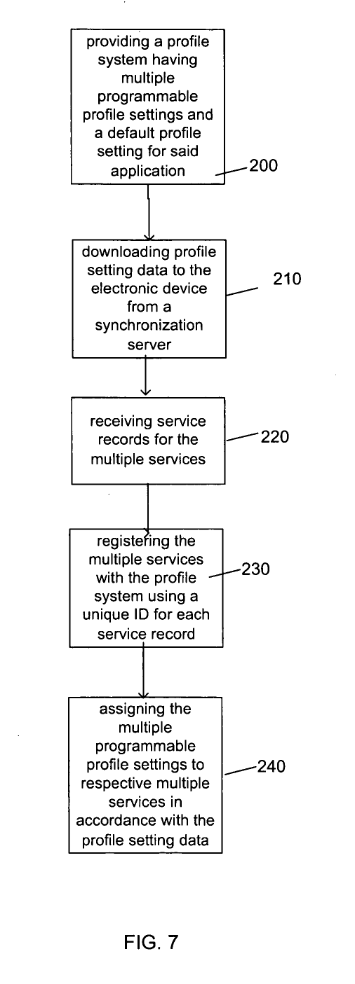

Turning to FIG. 7, a flowchart is provided showing a method for configuring unique profile settings for multiple services according to a further embodiment. In step 200, profile system 90 is provided having multiple programmable profile settings. In step 210, profile setting data is downloaded to the electronic device 10 from synchronization server 89. In step 220, service records are received for the multiple services from provisioning server 84. In step 230, the multiple services register with the profile system 90 using a unique ID for each service record. In step 240, the multiple services register with the profile system 90 using a unique ID for each service record. Then, at step 250, the multiple programmable profile settings are assigned to respective ones of the multiple services.

While the embodiment described herein is directed to a particular implementation for configuring unique profile settings for multiple services, it will be understood that the steps described hereinabove are not limited to the order in which they are described. The steps described can be performed in any suitable order as may occur to those skilled in the art.

Many other modifications and variations may occur to those skilled in the art. All such modifications and variations are believed to be within the sphere and scope of the present application.

What is claimed is:

1. A method for configuring unique profile settings for multiple services associated with an application in an electronic device, comprising:
providing a profile system having multiple programmable profile settings and a default profile setting for said application;
receiving service records for said multiple services;
registering said multiple services with said profile system using, a unique ID for each of said service records and data for identifying the default profile setting for said application;
initially assigning said default profile setting to each of said multiple services; and
subsequently assigning said multiple programmable profile settings to respective ones of said multiple services.

2. The method of claim 1, wherein said multiple programmable profile settings are assigned to said respective ones of said multiple services via a user interface.

3. The method of claim 1, wherein said multiple programmable profile settings are assigned to said respective ones of said multiple services as a result of downloading profile setting data during synchronization between said electronic device and a synchronization server.

4. A method for configuring unique profile settings for multiple services associated with an application in an electronic device, comprising:
providing a profile system having multiple programmable profile settings;
downloading profile setting data to said electronic device from a synchronization server;
receiving service records for said multiple services;
registering said multiple services with said profile system using a unique ID for each of said service records; and
assigning said multiple programmable profile settings to respective ones of said multiple services in accordance with said profile setting data.

5. The method of claim 4, wherein said profile setting data is stored in said electronic device in hidden files pending receipt of said service records.

6. The method of claim 5, wherein said profile setting data is discarded in the event said service records have not been received within a predetermined time period.

7. An apparatus for configuring unique profile settings for multiple services associated with an application in an electronic device, comprising:
a profile system having multiple programmable profile settings and a default profile setting for said application;
means for receiving service records for said multiple services;
means for registering said multiple services with said profile system using a unique ID for each of said service records and for including data for identifying the default profile setting for said application;
means for initially assigning said default profile setting to each of said multiple services; and
means for subsequently assigning said multiple programmable profile settings to respective ones of said multiple services.

8. The apparatus of claim 7, further comprising a user interface for assigning said multiple programmable profile settings to said respective ones of said multiple services.

9. The apparatus of claim 7, further comprising a synchronization server for downloading profile setting data to said electronic device whereupon said multiple programmable profile settings are assigned to said respective ones of said multiple services.

10. An apparatus for configuring unique profile settings for multiple services associated with an application in an electronic device, comprising:
a profile system having multiple programmable profile settings;
a synchronization server for downloading profile setting data to said electronic device;
means within said electronic device for receiving service records for said multiple services;
means within said electronic device for registering said multiple services with said profile system using a unique ID for each of said service records; and
means within said electronic device for assigning said multiple programmable profile settings to respective ones of said multiple services in accordance with said profile setting data.

11. The apparatus of claim 10, further comprising memory within said electronic device for storing said profile setting data as hidden files pending receipt of said service records.

12. The apparatus of claim 11, further comprising means for discarding said profile setting data in the event said service records have not been received within a predetermined time period.

13. A computer-readable medium having computer readable code embodied therein for:
providing a profile system having multiple programmable profile settings and a default profile setting for said application;
receiving service records for said multiple services;
registering said multiple services with said profile system using a unique ID for each of said service records and including data for identifying the default profile setting for said application;
initially assigning said default profile setting to each of said multiple services; and
subsequently assigning said multiple programmable profile settings to respective ones of said multiple services.

14. A computer-readable medium having computer readable code embodied therein for:
providing a profile system having multiple programmable profile settings and a default profile setting for said application;
downloading profile setting data to said electronic device from a synchronization server;
receiving service records for said multiple services;
registering said multiple services with said profile system using a unique ID for each of said service records; and
assigning said multiple programmable profile settings to respective ones of said multiple services in accordance with said profile setting data.
